(19) United States
(12) Patent Application Publication
(10) Pub. No.: US 2005/0213056 A1
(43) Pub. Date: Sep. 29, 2005

(54) Apparatus for positioning lens and image display apparatus having the same

(75) Inventor: Wen-Chung Ho, Taoyuan City (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/088,145

(22) Filed: Mar. 23, 2005

(30) Foreign Application Priority Data
Mar. 26, 2004 (TW) 93108302

(51) Int. Cl. G03B 21/14

(52) U.S. Cl. 353/100

(57) ABSTRACT

An apparatus for positioning a lens and an image display apparatus having the same are provided. The apparatus is configured to assemble a lens with a casing having an aperture. The apparatus includes a first ring and a second ring. The first ring is affixed to the casing corresponding to the aperture. The second ring is radially movably sleeved into the first ring. When the lens and the casing are assembled, the lens is sleeved into the second ring.

### CROSS-REFERENCE TO RELATED APPLICATIONS

This application claims the right of priority based on Taiwan Patent Application No. 093108302 entitled “Apparatus for Positioning Lens and Projector having the Same,” filed on Mar. 26, 2004, which is incorporated herein by reference and assigned to the assignee herein.

### FIELD OF INVENTION

The present invention generally relates to an apparatus for positioning a lens, and more particularly to an apparatus for assembling a lens, which is moveable with respect to a casing, and an image display apparatus having the same.

### BACKGROUND OF THE INVENTION

In the architecture of a projector-type image display apparatus, the lens opening generally varies with the design and the exterior appearance of the lens. However, regardless the type of lens design used, the gap between a lens and its holder is an important design consideration because the lens not only corresponds to the lens opening in one end, but also corresponds to other components at a different end. For example, one end of the lens typically corresponds to the lens opening; the other end of the lens is connected to a light engine. In other words, the lens is generally affixed with respect to the light engine and the housing of the projector. The manufacture tolerance and the assembly tolerance of each component often cause some interference between the lens and the opening. Accordingly, the assembly cost is increased, and the production yield is reduced.

A conventional technique is to increase the gap between the lens and the lens holder, so that the position of the lens can be adjusted. As the gap between the lens and the lens holder increases to a certain degree, an extra adjustment apparatus is necessary to control the adjustment of the position of the lens. Conventional adjustment apparatus manually adjusts the lens in a single direction at a time, resulting in the assembly procedure taking a long time, and the exterior appearance of the projector is inconsistent in production. Therefore, it is desirable to provide an apparatus capable of automatically adjusting the position of the lens so as to reduce the assembly cost and increase the yield.

### SUMMARY OF THE INVENTION

One aspect of the invention is to provide an apparatus for assembling a lens with a casing so as to reduce assembly interferences due to manufacture tolerances, and accordingly to increase the production yield and reduce the manufacture cost.

In one embodiment of the present invention, an apparatus for assembling a lens with a casing is provided. The casing is formed with an aperture. The apparatus includes a first ring and a second ring. The first ring is affixed on the casing and corresponds to the aperture. The second ring is radially movably sleeved into the first ring. When the lens and the casing are assembled, the lens is sleeved into the second ring.

Moreover, the first ring includes a ring body and a plurality of resilient members.

The resilient members are disposed on an inner rim of the ring body. Each of the resilient members provides an elastic force so that the second ring is radially movable within the inner rim of the first ring. The resilient members include a plurality of springs, which are substantially evenly disposed on the inner rim of the first ring. Furthermore, when the lens is sleeved into the second ring, the lens is rotatable with respect to the second ring. The second ring includes a ring body and a low friction unit. The low friction unit contacts the lens so as to allow the lens to rotate within the ring body of the second ring and restrain the lens from radially moving within the ring body of the second ring. The low friction unit includes a sphere or a roller. The apparatus further includes a pin for positioning the sphere or the roller so that the sphere or the roller is rotatably positioned on the ring body of the second ring.

Another aspect of the present invention is to provide an image display apparatus having the apparatus for assembling the lens as described above. The image display apparatus utilizes two rings with radially movable configurations, so as to adjust relative positions in response to the shift of the center of the lens to reduce the assembly interference and enhance the exterior appearance of the image display apparatus.

### BRIEF DESCRIPTION OF THE DRAWINGS

The foregoing objects and other objects together with the advantages of this invention will become more readily appreciated as the same becomes better understood by reference to the following detailed description, when taken in conjunction with the accompanying drawings, wherein:

FIG. 1 is an exploded drawing illustrating the elements of an apparatus for assembling a lens with a casing in accordance with an embodiment of the present invention;

FIGS. 2A and 2B are schematic enlarged views illustrating a first ring and a second ring in accordance with an embodiment of the present invention; and

FIGS. 3A and 3B are schematic side views showing the apparatus of the present invention when a lens is shifted.

### DETAILED DESCRIPTION

The present invention provides an apparatus for assembling a lens with a casing, which utilizes two rings with a radially shiftable configuration so as to reduce the assembly interferences due to manufacture tolerances and enhance the exterior appearance effect.

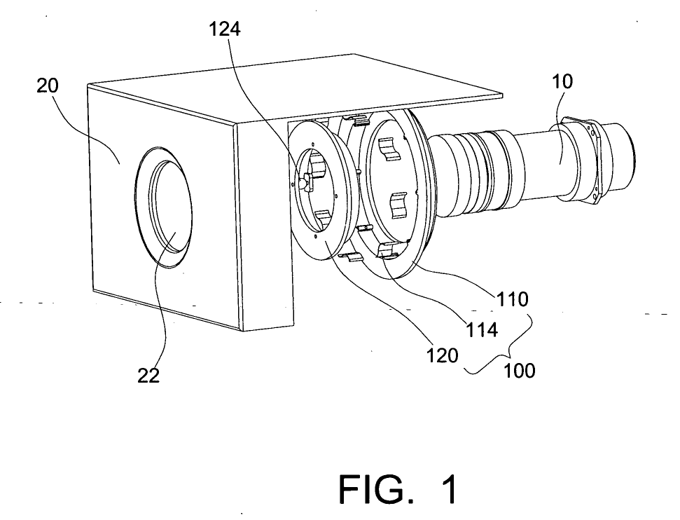

Preferred embodiments of the present invention are illustrated in FIGS. 1 to 3.

Referring to FIG. 1, in accordance with one embodiment of the present invention, an apparatus 100 for assembling a lens 10 with a casing 20 is provided. The apparatus 100 can be suitably implemented in various kinds of image display apparatus, such as a projector. When the apparatus 100 is implemented in a projector, the casing 20 can be the housing of the projector. The casing 20 is formed with an aperture 22 for allowing light to pass therethrough. In other words, when a projector is in use, the light signal generated by a light engine (not shown) is modulated by the lens and then projected through the aperture 22 of the casing 20 onto a target screen (not shown). As shown in FIG. 1, the apparatus 100 includes a first ring 110 and a second ring 120. The first ring 110 is to be affixed to the casing 20 and corresponds to the aperture 22. That is, the position of the first ring 110 is substantially fixed with respect to the casing 20. The second ring 120 is radially movably sleeved into the first ring 110. When the lens 10 is assembled with the casing 20, the lens 10 is sleeved into the second ring 120.

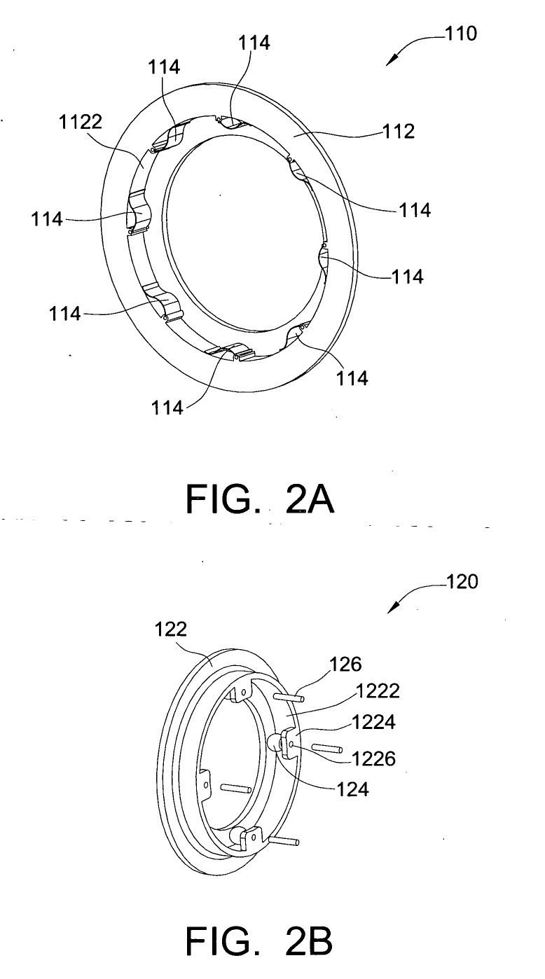

FIG. 2A illustrates an enlarged view of the first ring 110. As shown in FIG. 2A, the first ring 110 includes a ring body 112 and a plurality of resilient members 114. The ring body 112 has an inner rim 1122, and the resilient members 114 are disposed on the inner rim 1122. It is noted that the outer portion surrounding the ring body 112 can have a variety of forms and shapes as appropriate. Each of the resilient members 114 provides an elastic force, so that the second ring 120 is radially movable within the inner rim 1122 of the first ring 110. One exemplary resilient member 114 is a spring as shown in FIG. 2A. The springs 114 are substantially evenly disposed on the inner rim 1122 so as to provide elastic forces in multiple directions. It is noted that the number, the shape, or the arrangement of the springs are considered to provide the second ring 120 with appropriate elastic forces and are not to limit the fields of application of the invention. Furthermore, as shown in the enlarged view of the second ring 120 of FIG. 2B, the second ring 120 includes a ring body 122 and a low friction unit 124. The ring body 122 has an inner rim 1222, and the low friction unit 124 is disposed on the inner rim 1222 and contacts the lens 10. By such an arrangement, when the lens 10 is sleeved into the second ring 120, the lens 10 is allowed to rotate within the ring body 122, and the low friction unit 124 restrains the lens 10 from radially moving within the inner rim 1222. Exemplary low friction unit 124 includes at least one sphere or roller, which contacts the exterior portion of the lens 10 so as to allow the lens 10 to rotate within the inner rim 1222 and substantially restrain the lens from radially moving within the inner rim 1222. The apparatus 100 further includes a pin 126 for positioning the sphere or the roller 124, so that the sphere or the roller 124 is rotatably positioned on the ring body 122 of the second ring 120. As shown in FIG. 2B, the ring body 122 includes an extension portion 1224 with a hole 1226. The pin 126 is pinned into an aperture of the sphere or the roller 124 through the hole 1226 of the extension portion 1224, so that the sphere or the roller 124 is rotatably positioned on the ring body 122 of the second ring 120.

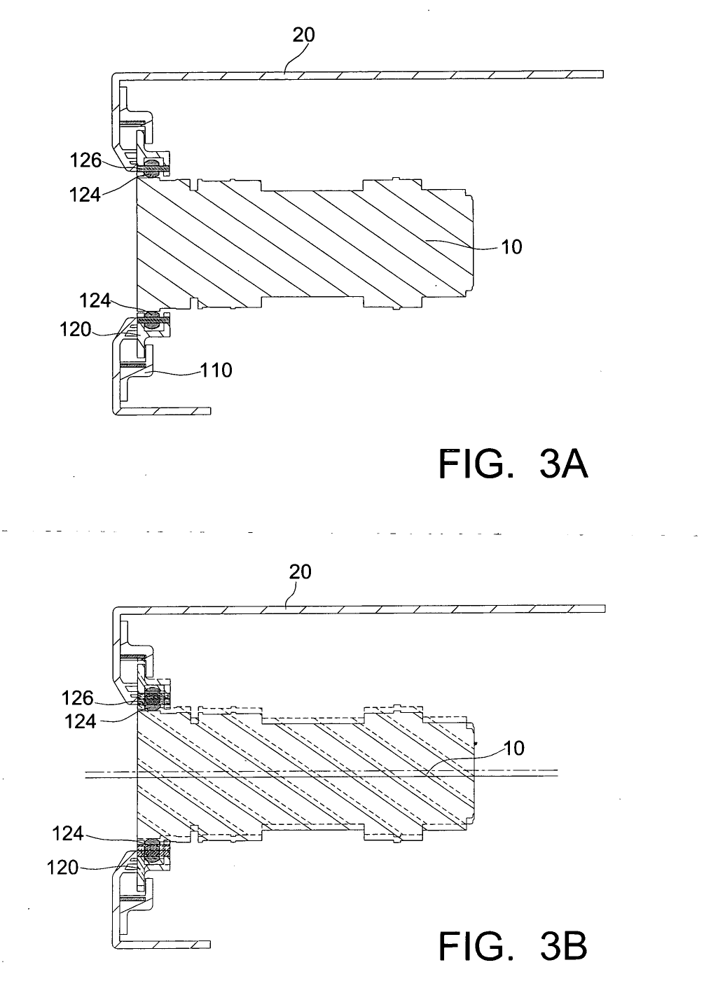

Referring to FIG. 3A, a side view of the lens 10 assembled with the casing 20 by the apparatus 100 is illustrated. As shown in FIG. 3A, the first ring 110 is affixed on the casing 20 and is in alignment with the aperture 22 so that the position of the first ring 110 is substantially fixed with respect to the casing 20. The second ring 120 is radially movably sleeved into the first ring 110. The resilient members 114 are disposed on the inner rim 1122 of the ring body 112 and contact the exterior portion of the ring body 122 of the second ring 120. When the lens 10 is assembled with the casing 20, the lens 10 is sleeved into the second ring 120. Each of the resilient members 114 of the first ring 110 provides an elastic force, so that the second ring 120 is automatically shifted in response to the position shift of the lens 10, which is caused by the manufacture tolerances of the lens 10 and the second ring 120 or the relative stationary relationship between the lens 10 and other components. Therefore, as one end of the lens 10 is sleeved into the second ring 120 and the other end is coupled to other components, such as a light engine or other mounting devices, the apparatus 100 is capable of automatically adjusting the relative position of the first ring 110 and the second ring 120 in response to the variation in position of the lens 10. Accordingly, the assembling interference problem caused by manufacture tolerances is resolved, and the assembling cost is reduced.

FIG. 3B illustrates the radial shift of the second ring 120 in response to the shift of the lens 10 when assembled. Because the second ring 120 is radially movable within the inner rim 1122 of the first ring 112, if the position of the lens 10 is shifted, the co-center axis of the second ring 120 and the lens 10 maintains unchanged so that the assembly interference would not likely happen. The dotted line shown in FIG. 3B represents the corresponding position after the shift. In other words, as the center axis of the lens 10 is shifted, the second ring 120 is automatically shifted in response to the shift of the lens 10 because the low friction unit (the sphere or the roller) 124 of the second ring 120 contacts the lens. Therefore, the interference between the lens 10 and the second ring 120 does not happen. Furthermore, because the second ring 120 shifts as the lens 10 shifts, the relative position of center axes of the lens 10 and the second ring 120 remains unchanged, so that the shift of the lens is not easily noticeable, and therefore the exterior appearance effect is improved. In other words, when the apparatus 100 is implemented in an image display apparatus, the position of the first ring 110 remains unchanged with respect to the casing 10 and corresponds to the aperture 22 of the casing 20, even when the second ring 120 shifts up, down, left or right in response to the shift of the lens 10. Therefore, as directly viewing the aperture 22 of the casing 20 together with the first ring 110, the shift of the lens 10 is not easily noticeable so that the exterior appearance effect is improved.

Moreover, the present invention also provides an image display apparatus, which includes the apparatus 100 for assembling the lens 10 and the casing 20, so that the assembling interference caused by manufacture tolerances is reduced and the exterior appearance effect is improved.

Although specific embodiments have been illustrated and described, it will be apparent that various modifications may fall within the scope of the appended claims.

1. An apparatus for assembling a lens with a casing formed with an aperture, comprising:
a first ring affixed to said casing and in alignment with said aperture; and
a second ring radially movably sleeved into said first ring,
wherein said lens is sleeved into said second ring when said lens and said casing are assembled.

2. The apparatus of claim 1, wherein said first ring comprises a ring body and a plurality of resilient members disposed on an inner rim of said ring body.

3. The apparatus of claim 2, wherein each of said resilient members provides an elastic force so that said second ring is radially movable within said first ring.

4. The apparatus of claim 2, wherein said plurality of resilient members comprises a plurality of springs substantially evenly disposed on said inner rim of said first ring.

5. The apparatus of claim 1, wherein said lens is rotatable with respect to said second ring.

6. The apparatus of claim 5, wherein said second ring comprises a ring body and a low friction unit, said low friction unit contacts said lens so as to allow said lens to rotate within said ring body and restrain said lens from radially moving within said ring body.

7. The apparatus of claim 6, wherein said low friction unit comprises a sphere or a roller.

8. The apparatus of claim 7, further comprising a pin for positioning said sphere or said roller so that said sphere or said roller is rotatably positioned on said ring body of said second ring.

9. An image display apparatus, comprising:
a casing having an aperture;
a lens for modulating a light beam;
a first ring being affixed on said casing corresponding to said aperture; and
a second ring being movably sleeved into said first ring,
wherein said lens is sleeved into said second ring when said lens and said casing are assembled.

10. The image display apparatus of claim 9, wherein said first ring comprises a ring body and a plurality of resilient members disposed on an inner rim of said ring body.

11. The apparatus of claim 10, wherein each of said plurality of resilient members provides an elastic force so that said second ring is radially movable within said first ring.

12. The apparatus of claim 10, wherein said plurality of resilient members comprises a plurality of springs substantially evenly disposed on said inner rim of said first ring.

13. The apparatus of claim 9, wherein said lens is rotatable with respect to said second ring.

14. The apparatus of claim 13, wherein said second ring comprises a ring body and a unit of low friction, said unit contacts said lens so as to allow said lens to rotate within said ring body and restrain said lens from radially moving within said ring body.

15. The apparatus of claim 14, wherein said unit comprises a sphere or a roller.

16. The apparatus of claim 15, further comprising a pin for positioning said sphere or said roller so that said sphere or said roller is rotatably positioned on said ring body of said second ring.
